(19) United States
(12) Patent Application Publication
(10) Pub. No.: US 2007/0211024 A1
(43) Pub. Date: Sep. 13, 2007

(54) Plasma display panel

(76) Inventors: Jae-Ik Kwon, Suwon-si (KR); Won-Ju Yi, Suwon-si (KR); Ho-Young Ahn, Suwon-si (KR); Kyoung-Doo Kang, Suwon-si (KR); Soo-Ho Park, Suwon-si (KR); Seok-Gyun Woo, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/716,009

(22) Filed: Mar. 9, 2007

(30) Foreign Application Priority Data
Mar. 10, 2006 (KR) 10-2006-0022709

(51) Int. Cl. G09G 5/00

(52) U.S. Cl. 345/156

(57) ABSTRACT

A plasma display panel includes first and second substrates arranged facing each other, barrier ribs between the first and second substrates, the barrier ribs defining a displaying domain including discharge cells and a non-displaying domain, and first and second discharge electrodes, each discharge electrode including a discharge portion in the displaying domain and an end portion in the non-displaying domain, the discharge electrodes being inside the barrier ribs, wherein a thickness of a portion of a barrier rib covering a portion of a side of an end portion is greater than a thickness of a portion of the barrier rib covering a portion of a side of a discharge portion.

### BACKGROUND OF THE INVENTION

1. Field of the Invention

The present invention relates to a plasma display panel. More particularly, the present invention relates to a plasma display panel having a structure that reduces dielectric breakdown due to the discharge of discharge electrodes, allowing a large discharge gap, and resulting excellent luminous efficiency, to be realized.

2. Description of the Related Art

Plasma display panels (PDP) are flat display panels that display an image using a gas discharge, and are considered to be the next generation of flat display panels due to desirable display properties, e.g., thinness, display capacity, brightness, contrast, afterimage, and viewing angle.

However, conventional PDP technology has not addressed some of the problems associated with plasma display panels, e.g., dielectric breakdown due to the discharge of discharge electrodes, which limits a size of a discharge gap, resulting in low luminous efficiency.

### SUMMARY OF THE INVENTION

The present invention is therefore directed to a plasma display panel, which substantially overcomes one or more of the problems due to the limitations and disadvantages of the related art.

It is therefore a feature of the present invention to provide a plasma display panel having a structure that reduces dielectric breakdown due to the discharge of discharge electrodes.

It is therefore another feature of the present invention to provide a plasma display panel having a large discharge gap.

It is therefore another feature of an embodiment of the present invention to provide a plasma display panel having excellent luminous efficiency.

At least one of the above and other features and advantages of the present invention may be realized by providing a plasma display panel including first and second substrates arranged facing each other, barrier ribs between the first and second substrates, the barrier ribs defining a displaying domain including discharge cells and a non-displaying domain, and first discharge electrodes between the first and second substrates, each first discharge electrode including a first discharge portion in the displaying domain and a first end portion in the non-displaying domain, the first discharge electrodes being inside the barrier ribs, wherein a thickness of a portion of a barrier rib covering a portion of a side of the first end portion is greater than a thickness of a portion of the barrier rib covering a portion of a side of the first discharge portion, and second discharge electrodes between the first and second substrates and facing the first discharge electrodes, each second discharge electrode including a second discharge portion in the displaying domain and a second end portion in the non-displaying domain, the second discharge electrodes being inside the barrier ribs, wherein a thickness of a portion of a barrier rib covering a portion of a side of the second end portion is greater than a thickness of a portion of the barrier rib covering a portion of a side of the second discharge portion.

A thickness of a portion of the barrier rib covering an edge of the first end portion may be greater than the thickness of the portion of the barrier rib covering the portion of the side of the first discharge portion, and a thickness of a portion of the barrier rib covering an edge of the second end portion may be greater than the thickness of the portion of the barrier rib covering the portion of the side of the second discharge portion.

The barrier ribs may further define a plurality of dummy cells in the non-displaying domain. A width of a portion of the barrier ribs defining the dummy cells may be greater than a width of a portion of the first barrier ribs defining the discharge cells.

The barrier ribs may include lengthwise barrier rib portions parallel to the first and second discharge electrodes and crosswise barrier rib portions intersecting the lengthwise barrier rib portions. The barrier ribs further define a plurality of dummy cells in the non-displaying domain. A width of the lengthwise barrier rib portions defining the dummy cells may be greater than a width of the lengthwise barrier rib portions defining the discharge cells. One discharge electrode may extend along a respective lengthwise barrier rib portion. Each first discharge portion may include a first body portion inside the lengthwise barrier rib portions, and first branch portions extending from the first body portion inside of the crosswise barrier rib portions, and each second discharge portion may include a second body portion inside the lengthwise barrier rib portions, and second branch portions extending from the body portion inside the crosswise barrier rib portion.

The barrier ribs may cover the non-displaying domain in its entirety. The first and second discharge electrodes may be shared with adjacent discharge cells.

The plasma display panel may include additional barrier ribs between the barrier ribs and at least one of the first substrate and the second substrate, and phosphor may be within spaces defined by the additional barrier ribs.

The first discharge electrodes may include first terminal portions extending from the discharge portions opposite the end portions, and the second discharge electrodes may include second terminal portions extending from the second discharge portions opposite the second end portions. First and second terminal portions of the first and second discharge electrodes may be on opposite sides of the plasma display panel.

The first and second discharge electrodes may form stripe patterns. The plasma display panel may include address electrodes disposed on the first substrate or on the second substrate, crossing the first and second discharge electrodes. The plasma display panel may include phosphor layers disposed inside the discharge cells.

### BRIEF DESCRIPTION OF THE DRAWINGS

The above and other features and advantages of the present invention will become more apparent by describing in detail exemplary embodiments thereof with reference to the attached drawings, in which:

FIG. 1 illustrates a schematic plan view of a plasma display panel according to an embodiment of the present invention;

FIG. 2 illustrates a partial exploded perspective view of the plasma display panel of FIG. 1;

FIG. 3 illustrates a layout diagram of first barrier ribs, first discharge electrodes, second discharge electrodes and address electrodes of the plasma display panel of FIG. 2;

FIG. 4 illustrates a layout diagram of first barrier ribs, first discharge electrodes, second discharge electrodes and address electrodes according to another embodiment of the present invention; and

FIG. 5 illustrates a layout diagram of first barrier ribs, first discharge electrodes, second discharge electrodes and address electrodes according to another embodiment of the present invention.

### DETAILED DESCRIPTION OF THE INVENTION

Korean Patent Application No. 10-2006-0022709, filed on Mar. 10, 2006, in the Korean Intellectual Property Office, and entitled: “Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

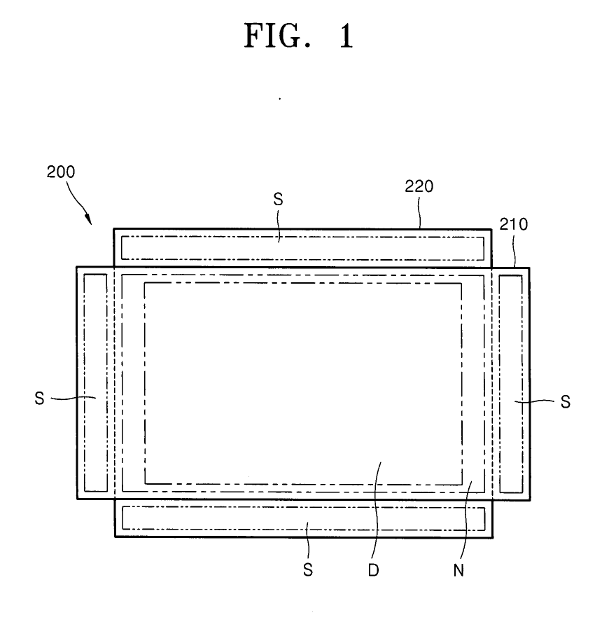

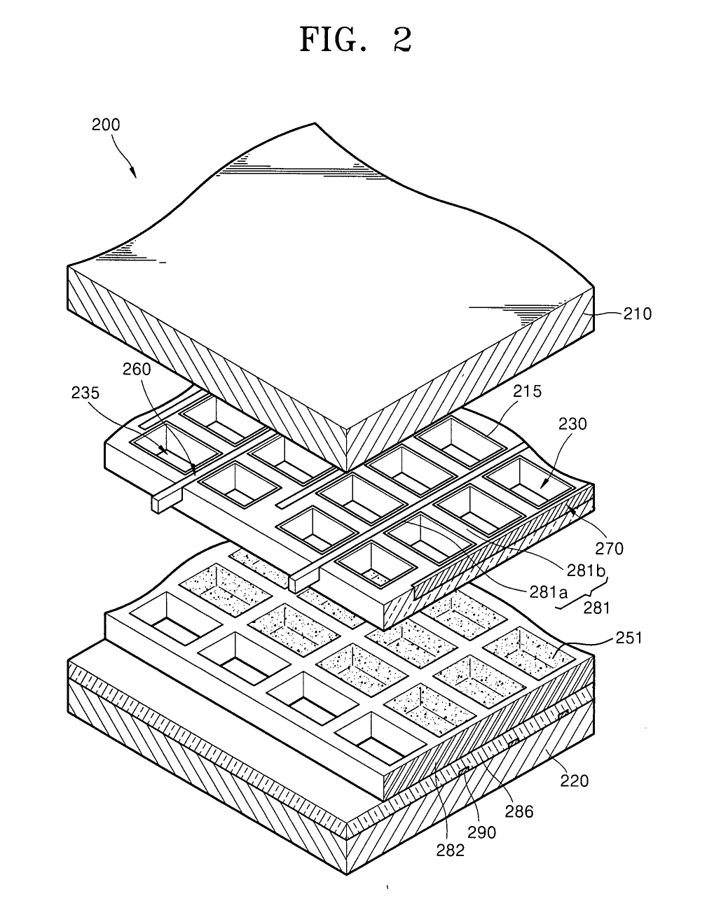

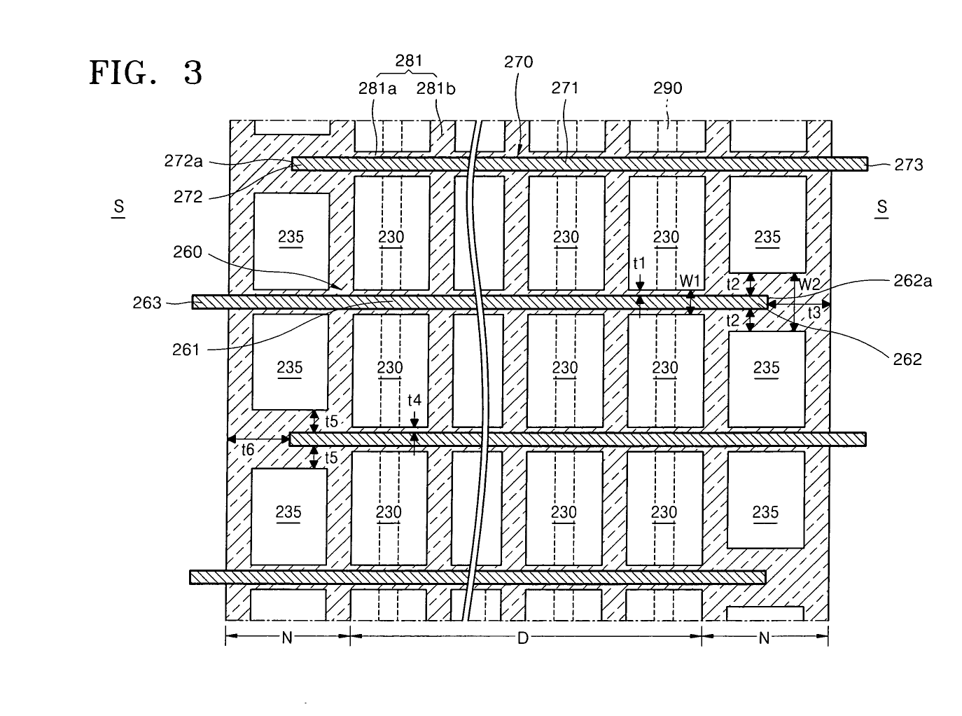

A plasma display panel 200, according to an embodiment of the present invention, is illustrated in FIGS. 1 through 3. FIG. 1 illustrates a schematic plan view of the plasma display panel 200, FIG. 2 illustrates a partial exploded perspective view of the plasma display panel 200 of FIG. 1, and FIG. 3 illustrates a layout diagram of first barrier ribs 281, first discharge electrodes 260, second discharge electrodes 270 and address electrodes 290 of the plasma display panel 200.

Referring to FIG. 1, the plasma display panel 200 may include a first substrate 210 and a second substrate 220 spaced apart from each other and facing each other. Portions where the first substrate 210 and the second substrate 220 overlap may define a displaying domain D that displays an image and a non-displaying domain N outside the displaying domain D. Portions where the first substrate 210 and the second substrate 220 do not overlap may include a terminal portion domain S. The first substrate 210 and the second substrate 220 may be, e.g., glass, and may be colored to reduce reflective brightness for improving bright room contrast.

Referring to FIGS. 2 and 3, the plasma display panel 200 may include first barrier ribs 281 defining a plurality of discharge cells 230 and dummy cells 235. The discharge cells 230 may correspond to the displaying domain D, and the dummy cells 235 may correspond to the non-displaying domain N. The first barrier ribs 281 may include lengthwise barrier rib portions 281 a parallel to the first and the second discharge electrodes 260 and 270, and crosswise barrier rib portions 281b crossing the lengthwise barrier rib portions 281a. The first barrier ribs 281 may be made of an insulating material, e.g., a dielectric material.

FIGS. 2 and 3 illustrate both the discharge cells 230 and the dummy cells 235 as having rectangular cross sections defined by the first barrier ribs 281, but the discharge cells 230 and dummy cells 235 need not be limited thereto. That is, both the discharge cells 230 and the dummy cells 235 may be defined by the first barrier ribs 281 to have polygonal cross sections, e.g., triangular cross sections, tetragonal cross sections, pentagonal cross sections, etc., or circular or oval cross sections.

Referring to FIG. 2, the first discharge electrodes 260 and the second discharge electrodes 270 may be between the first substrate 210 and the second substrate 220. A pair of discharge electrodes, each pair including a first discharge electrode 260 and a second discharge electrode 270, may generate discharge in one discharge cell 230. Relative to each discharge cell 230, the first discharge electrode 260 and the second discharge electrode 270 of each pair may face each other. Also, the first discharge electrode 260 and the second discharge electrode 270 may be arranged in a stripe pattern and may be parallel to each other.

There may be a large gap between the first discharge electrode 260 and the second discharge electrode 270 of each pair, whereby the first discharge electrode 260 and the second discharge electrode 270 may generate a large gap discharge. Accordingly, each discharge cell 230 of the plasma display panel 200 may discharge over a large region, which may remarkably improve the luminous efficiency of the plasma display panel 200. However, a voltage required to produce such a large gap discharge may result in damage to the first barrier ribs 281 at portions adjacent the first discharge electrode 260 and/or the second discharge electrode 270.

Referring to FIG. 3, each first discharge electrode 260 may extend to the inside of the non-displaying domain N, across the terminal portion domain S and the displaying domain D. Each first discharge electrode 260 may include a first discharge portion 261 corresponding to the displaying domain D, a first end portion 262 extending from the first discharge portion 261 and corresponding to the non-displaying domain N, and a first terminal portion 263 extending from the first discharge portion 261, opposite the first end portion 262, and corresponding to the terminal portion domain S. Also, each second discharge electrode 270 may extend inside the non-displaying domain N to the terminal portion domain S and the displaying domain D. Each second discharge electrode 270 may include a second discharge portion 271 corresponding to the displaying domain D, a second end portion 272 extending from the second discharge portion 271 and corresponding to the non-displaying domain N, and a second terminal portion 273 extending from the second discharge portion 271, opposite the second end portion 272, and corresponding to the terminal portion domain S.

According to FIG. 3, the first terminal portions 263 may be on the left terminal portion domain S, and the second terminal portions 273 may be on the right terminal portion domain S. The first and second discharge portions 261 and 271 and the first and second end portions 262 and 272 may be inside the first barrier ribs 281. The first and second terminal portions 263 and 273 may be outside the first barrier ribs 281.

Referring to FIG. 3, widths W2 of the lengthwise barrier rib portions 281a that define the dummy cells 235 may be greater than widths W1 of the lengthwise barrier rib portions 281a that define the discharge cells 230. That is, the thicknesses t2 and t5 of the portions of the first barrier ribs 281 that cover the portions of sides of the first end portions 262 and the second end portions 272 may be greater than thicknesses t1 and t4 of the portions of the first barrier ribs 281 that cover the portions of sides of the first discharge portions 261 and the second discharge portions 271. Also, thicknesses t3 and t6 of the portions of the first barrier ribs 281 that cover edges 262a of the first end portions 262 and edges 272a of the second end portions 272 may be greater than the thicknesses t1 and t4 of the portions of the first barrier ribs 281 that cover the portions of sides of the first discharge portions 261 and the second discharge portions 271.

When the plasma display panel 200 is operated, an electric field may be concentrated on the first end portions 262 and the second end portions 272. However, since the thicknesses t2, t3, t5 and t6 of the portions of the first barrier ribs 281 that cover the first end portions 262 and the second end portions 272 may be relatively greater than the thicknesses t1 and t4 of the portions of the first barrier ribs 281 that cover the portions of sides of the first discharge portions 261 and the second discharge portions 271, damage to the first barrier ribs 281 due to electric field concentration may be significantly reduced, and may be very low.

Referring to FIG. 3, each first discharge electrode 260 and second discharge electrode 270 may operate on adjacent discharge cells 230 between the lengthwise barrier rib portions 281a. Accordingly, both the first discharge electrodes 260 and the second discharge electrodes 270 may not be on the same lengthwise barrier rib portion 281a, which may allow the width of the lengthwise barrier rib portion 281a to be reduced, further increasing a length of a discharge gap.

The plasma display panel 200 may include a three-electrode structure, as illustrated in FIG. 2. In another implementation, either the first discharge electrodes 260 or the second discharge electrodes 270 may serve as address electrodes, and the other discharge electrodes may serve as sustain electrodes. For example, the first discharge electrodes 260 may serve as address electrodes and the second discharge electrodes 270 may serve as sustain electrodes.

Referring to FIGS. 2 and 3, the first discharge electrodes 260 and the second discharge electrodes 270 may be in the first barrier ribs 281, so that the transmission of visible light may not be decreased. Accordingly, the first discharge electrodes 260 and the second discharge electrodes 270 may be a conductive material, e.g., aluminum, copper, etc. The conductive material may have a small voltage drop, so that the first discharge electrodes 260 and the second discharge electrodes 270 may stably transmit signals.

The first barrier ribs 281 prevent the first discharge electrodes 260 and the second discharge electrodes 270 from directly contacting each other, and prevent the first discharge electrodes 260 and the second discharge electrodes 270 from being damaged due to direct collisions of positive ions and electrons. Also, the first barrier ribs 281 may accumulate wall charges by inducing charges. Accordingly, the first barrier ribs 281 may be made of a dielectric material.

Referring to FIGS. 2 and 3, the plasma display panel 200 may further include the address electrodes 290 parallel to each other and spaced apart from each other on the second substrate 220. The address electrodes 290 may cross the first and second discharge electrodes 260 and 270 in a stripe pattern. Alternatively, the address electrodes 290 may be on the first substrate 210. The address electrodes 290 may generate an address discharge for selecting a discharge cell to be illuminated by sustain discharge between the first discharge electrode 260 and the second discharge electrode 270. An address voltage supplied by the address electrodes 290 may lower the voltage required for a sustain discharge. The address electrodes 290 may be covered by a dielectric layer 286.

In FIG. 2, the plasma display panel 200 may further include protective layers 215 on sidewalls of the first barrier ribs 281. The protective layers 215 may prevent damage of the first barrier ribs 281 due to plasma particles. Also, the protective layers 215 may generate secondary electrons to reduce discharge voltage. The protective layers 215 may be formed, e.g., by coating magnesium oxide (MgO) on the sidewalls of the first barrier ribs 281.

Second barrier ribs 282 may be between the second substrate 220 and the first barrier ribs 281. The second barrier ribs 282 may define the spaces where phosphor layers 251 may be formed. Alternatively, the second barrier ribs 282 may be between the first substrate 210 and the first barrier ribs 281. The second barrier ribs 282 may have substantially the same shapes as the first barrier ribs 281, and may be formed as a single body.

The phosphor layers 251 may be on sidewalls of the second barrier ribs 282 and on the dielectric layer 286. The phosphor layers 251 may include, e.g., red, green and blue luminous phosphor layers, and may generate visible light in response to ultraviolet rays. The red luminous phosphor layers may include, e.g., Y(V,P)O₄:Eu, etc.; the green luminous phosphor layers may include, e.g., Zn₂SiO₄:Mn, YBO₃:Tb, etc.; and the blue luminous phosphor layers may include, e.g. BAM:Eu, etc. Areas where the phosphor layers 251 are provided may be enlarged due to the second barrier ribs 282, so that brightness and luminous efficiency of the plasma display panel 200 may be improved.

The boundary of the first substrate 210 and the second substrate 220 may be sealed using a sealing material, e.g., frit glass. A discharge gas, e.g., Ne, Xe, etc., or a mixture thereof may be supplied to the discharge cells 230 after the first substrate 210 and the second substrate 220 have been sealed.

A method of operating the plasma display panel 200, according to an embodiment of the present invention, will now be described.

An address discharge may be generated between a first discharge electrode 260 and an address electrode 290, resulting in the selection of a discharge cell 230 in which a sustain discharge is to be generated. Thereafter, when the sustain voltage is applied between the first discharge electrode 260 and the second discharge electrode 270 of the selected cell 230, sustain discharge is generated between the first and second discharge electrodes 260 and 270. As the energy level of the discharge gas excited by the sustain discharge is reduced, ultraviolet light is discharged. The ultraviolet rays excite the phosphor layers 251, which generate visible light to form an image as the energy level of the excited phosphor layers 251 is reduced.

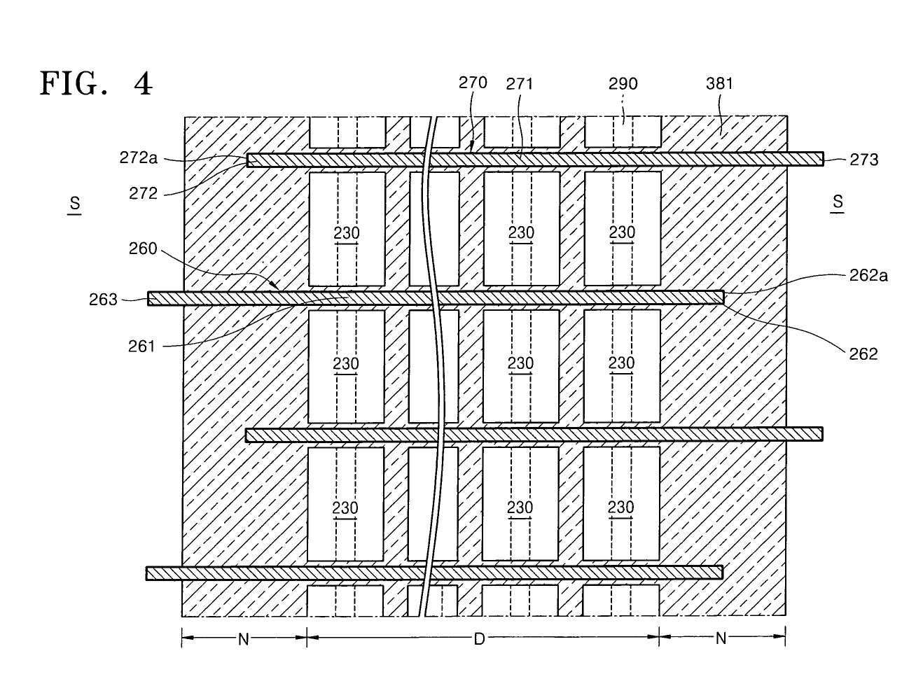

FIG. 4 illustrates a layout diagram according to another embodiment of the present invention. As illustrated in FIG. 4, first barrier ribs 381 may differ from the first barrier ribs 281 of FIG. 3. FIG. 4 illustrates that the thicknesses t2 and t5 of portions of the first barrier ribs 381 that cover portions of the sides of first end portions 262 and second end portions 272 may be maximized, i.e., the dummy cells 235 illustrated in FIG. 3 may be filled by the first barrier ribs 381 and may no longer be visible. That is, as illustrated in FIG. 4, the first barrier ribs 381 may entirely cover the non-displaying domain N. Therefore, by maximizing the thicknesses t2, t3, t5 and t6 of the portions of the first barrier ribs 281 that cover the first end portions 262 and the second end portions 272, damage to the portions of the first barrier ribs 281 covering the first end portions 262 and the second end portions 272 may be further minimized.

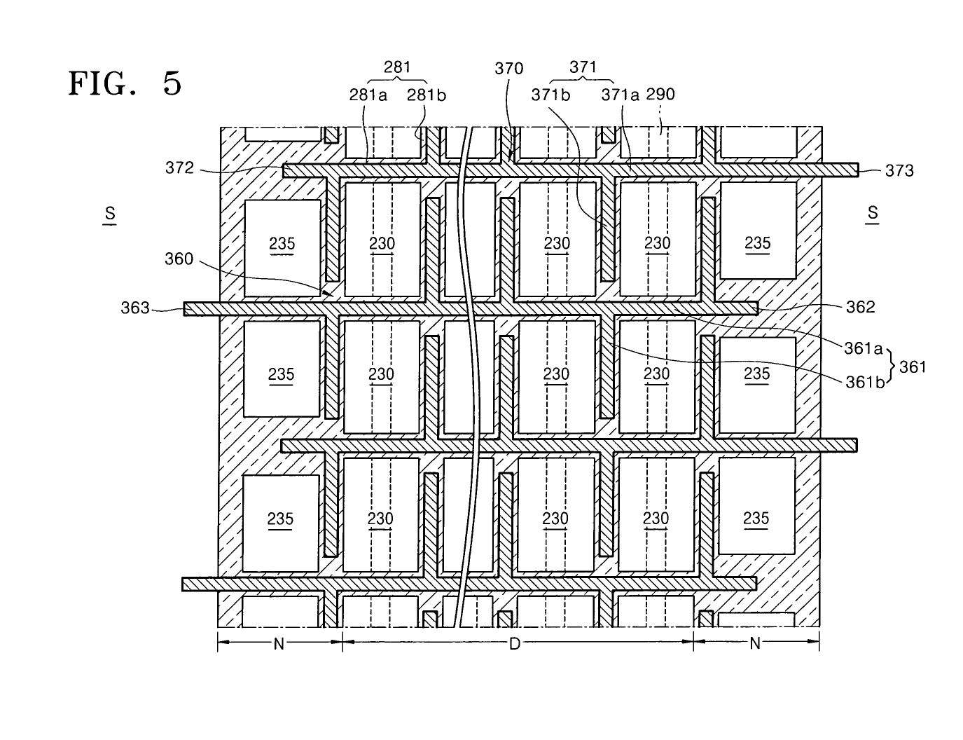

FIG. 5 illustrates a layout diagram according to yet another embodiment of the present invention. As illustrated in FIG. 5, the shape and/or configuration of first and second discharge electrodes 360 and 370 may differ from the first and second discharge electrodes 260 and 270 illustrated in FIG. 3.

Referring to FIG. 5, each first discharge electrode 360 may include a first discharge portion 361, a first end portion 362, and a first terminal portion 363. The first discharge portion 361 may include a first body portion 361a extending lengthwise inside the barrier rib portions 281a, and first branch portions 361b extending lengthwise inside the barrier rib portions 281b, such that the first branch portions 361b extend from, e.g., orthogonal to, the first discharge portion 361a. Similarly, each second discharge electrode 370 may include a second discharge portion 371, a second end portion 372, and a second terminal portion 373. The second discharge portion 371 may include a second body portion 371a extending lengthwise inside the barrier rib portions 281a, and second branch portions 371b extending lengthwise inside the barrier rib portions 281b, such that the second branch portions 371b extend from, e.g., orthogonal to, the second discharge portion 371a. Based on this shape and configuration, the area where discharge may be generated by each discharge cell 230 may be significantly enlarged, which may significantly increase brightness of the plasma display panel 200.

A plasma display panel according to the present invention may have excellent luminous efficiency due to a long gap discharge which may be generated between first discharge electrodes and second discharge electrodes. Also, damage to first barrier ribs due to discharge may be relatively low.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
first and second substrates arranged facing each other;
barrier ribs between the first and second substrates, the barrier ribs defining a displaying domain including discharge cells and a non-displaying domain;
first discharge electrodes between the first and second substrates, each first discharge electrode including a first discharge portion in the displaying domain and a first end portion in the non-displaying domain, the first discharge electrodes being inside the barrier ribs, wherein a thickness of a portion of a barrier rib covering a portion of a side of the first end portion is greater than a thickness of a portion of the barrier rib covering a portion of a side of the first discharge portion; and
second discharge electrodes between the first and second substrates and facing the first discharge electrodes, each second discharge electrode including a second discharge portion in the displaying domain and a second end portion in the non-displaying domain, the second discharge electrodes being inside the barrier ribs, wherein a thickness of a portion of a barrier rib covering a portion of a side of the second end portion is greater than a thickness of a portion of the barrier rib covering a portion of a side of the second discharge portion.

2. The plasma display panel as claimed in claim 1, wherein:
a thickness of a portion of the barrier rib covering an edge of the first end portion is greater than the thickness of the portion of the barrier rib covering the portion of the side of the first discharge portion; and
a thickness of a portion of the barrier rib covering an edge of the second end portion is greater than the thickness of the portion of the barrier rib covering the portion of the side of the second discharge portion.

3. The plasma display panel as claimed in claim 1, wherein the barrier ribs further define a plurality of dummy cells in the non-displaying domain.

4. The plasma display panel as claimed in claim 3, wherein a width of a portion of the barrier ribs defining the dummy cells is greater than a width of a portion of the barrier ribs defining the discharge cells.

5. The plasma display panel as claimed in claim 1, wherein the barrier ribs comprise:
lengthwise barrier rib portions parallel to the first and second discharge electrodes; and
crosswise barrier rib portions intersecting the lengthwise barrier rib portions.

6. The plasma display panel as claimed in claim 5, wherein the barrier ribs further define a plurality of dummy cells in the non-displaying domain, wherein a width of the lengthwise barrier rib portions defining the dummy cells is greater than a width of the lengthwise barrier rib portions defining the discharge cells.

7. The plasma display panel as claimed in claim 5, wherein:
each first discharge portion includes a first body portion inside the lengthwise barrier rib portions, and first branch portions extending from the body portion inside the crosswise barrier rib portions; and
each second discharge portion includes a second body portion inside the lengthwise barrier rib portions, and second branch portions extending from the body portion inside the crosswise barrier rib portions.

8. The plasma display panel as claimed in claim 1, wherein the barrier ribs cover the non-displaying domain in its entirety.

9. The plasma display panel as claimed in claim 1, wherein the first and second discharge electrodes are shared with adjacent discharge cells.

10. The plasma display panel as claimed in claim 1, further comprising additional barrier ribs between the barrier ribs and at least one of the first substrate and the second substrate, wherein phosphor is within spaces defined by the additional barrier ribs.

11. The plasma display panel as claimed in claim 1, wherein:
the first discharge electrodes include first terminal portions extending from the first discharge portions opposite the first end portions; and
the second discharge electrodes include second terminal portions extending from the second discharge portions opposite the second end portions.

12. The plasma display panel as claimed in claim 11, wherein the first and second terminal portions are on opposite sides of the plasma display panel.

13. The plasma display panel as claimed in claim 1, wherein the first discharge electrodes and the second discharge electrodes are parallel to each other.

14. The plasma display panel as claimed in claim 1, wherein the first and second discharge electrodes comprise stripe patterns.

15. The plasma display panel as claimed in claim 1, further comprising address electrodes disposed on the first substrate or on the second substrate, crossing the first and second discharge electrodes.

16. The plasma display panel as claimed in claim 1, further comprising phosphor layers disposed inside the discharge cells.
